(19) United States
(12) Patent Application Publication
(10) Pub. No.: US 2009/0004396 A1
(43) Pub. Date: Jan. 1, 2009

(54) Highly-Branched, Allyl Ether-Functionalized, Unsaturated Polyester Resins and Coating Compositions of the Same

(75) Inventors: Shaobing Wu, Jamestown, NC (US); Larry Brandenburger, Lino Lakes, MN (US); Thomas Melnyk, Greenfield, MN (US)

Correspondence Address: IPLM GROUP, P.A., POST OFFICE BOX 18455, MINNEAPOLIS, MN, 55418, US

(73) Assignee: Valspar Corporation, Minneapolis, MN (US)

(21) Appl. No.: 11/768,296

(22) Filed: Jun. 26, 2007

(51) Int. Cl. C08G 63/02; B05D 3/02; C08F 8/30

(52) U.S. Cl. 427/393.5; 106/287.24; 525/123

(57) ABSTRACT

The synthesis of highly-branched, allyl ether-functionalized, unsaturated polyester resins is disclosed herein, along with the utility of these resins in formulating formaldehyde-free, isocyanate-free, and styrene-free, low temperature and fast curing solvent-borne coatings, including wood coatings, and their use as alternatives for conventional acid catalyzed urea- or melamine-crosslinked coating systems.

### TECHNICAL FIELD OF THE INVENTION

This invention relates to resin compositions comprising functionalized unsaturated polyesters which are low-temperature curable, coating compositions comprising the resins, and methods of making the same.

### BACKGROUND OF THE INVENTION

Many traditional coating compositions are based on crosslinked urea/melamine-formaldehyde resins, which can afford excellent performance and cost efficiency. However, the health risks associated with exposure to volatile formaldehyde that is released from these coatings have prompted the coatings industry to search for new alternatives. Isocyanate-crosslinked coating systems have offered one approach to eliminate the formaldehyde issue, but these systems also have been fraught with health risks associated with irritation and sensitization to such materials, as well as higher raw materials cost. Further alternatives such as epoxy- or aziridine-based compositions are disfavored due to their expense and for their relatively high temperature curing requirement. Organic peroxide-cured polyester coatings combined with metal driers have been employed successfully in the gel coating industry for some time. However, the volatility and toxicity of styrene, relatively high curing temperatures, and the strong color development lessen the appeal of these coating systems.

Accordingly, there is a continuing need in the coatings industry to discover and develop alternative yet practical coatings systems which are formaldehyde- and isocyanate-free. This need encompasses the search for resins and coating systems that can cure under conditions no more stringent that the current urea/melamine-formaldehyde resin crosslinking conditions, with manageable raw material cost increases. In particular, there is a need for relatively low-temperature curable compositions, which are applicable to thermally-sensitive materials such as plastics, wood products, or any other material that is not conducive to high-temperature cure.

### SUMMARY OF THE INVENTION

The present disclosure provides for highly-branched, allyl ether-functionalized, unsaturated polyester resins and methods for the synthesis of these resins. As disclosed herein, the molecular weight and morphology of these resins can be controlled in the process of their preparation. Moreover, the present resins can be used to formulate formaldehyde-free, styrene-free, and isocyanate-free, one- or two-component coating compositions that are capable of curing quickly at relatively low temperatures. For example, the first component of a typical two-component coating system can include the highly-branched, unsaturated, allyl ether functionalized polyester resins described herein, along with any acrylic- or acrylate-functionalized co-reactants, resin modifiers, coating additives, and the like, while the second component of atypical two-component coating composition can include at least one peroxide compound, such as an organic peroxide. In this aspect, the typical two-component coating composition can be cured at a temperature of about 50° C. within about 10 minutes or at about room temperature within about 12 hours, without substantial darkening or color development.

One aspect of this invention provides for a resin composition comprising the contact product of:

(a) a hydroxyl-functionalized, allyl ether-functionalized, optionally carboxyl-functionalized, unsaturated polyester; and

(b) a polyisocyanate, an isocyanate prepolymer, or a combination thereof.

This contact product can comprise a highly-branched, allyl ether-functionalized, unsaturated polyester as described herein. Moreover, the hydroxyl-functionalized, allyl ether-functionalized, optionally carboxyl-functionalized, unsaturated polyester used to synthesize this contact product can be prepared by:

(a) contacting
(i) an acid-functionalized, unsaturated polyester prepolymer; and
(ii) a hydroxyl-functionalized, optionally carboxyl-functionalized allyl ether; or

(b) contacting, at substantially the same time,
(i) a polyacid, an anhydride, or any combination thereof;
(ii) a polyol; and
(iii) a hydroxyl-functionalized, optionally carboxyl-functionalized, allyl ether.

One example of this preparative process is provided in the synthesis of the unsaturated polyester that is hydroxyl-functionalized, allyl ether-functionalized, and optionally carboxyl-functionalized, by contacting, at substantially the same time:

(a) maleic anhydride (MA), phthalic anhydride (PA), or a combination thereof;

(b) ethylene glycol (EG), propylene glycol (PG), or a combination thereof; and

(c) trimethylolpropane diallyl ether (TMPDE), trimethylolpropane monoallyl ether (TMPME), or a combination thereof.

A further aspect of this disclosure provides a coating composition comprising the contact product of a first component and a second component, wherein:

(a) the first component comprises the contact product of:
(i) a highly-branched, allyl ether-functionalized, unsaturated polyester resin;
(ii) optionally, a polyacrylate, a polymethylacrylate, a polymethyl methacrylate, a polyethylene glycol acrylate, a polyethylene glycol methylacrylate, a polyethylene glycol methyl methacrylate, or any combination thereof; and
(iii) optionally, at least one thermoplastic resin modifier, at least one metal drier, at least one pigment, at least one filler, at least one wax, at least one colorant, at least one surface active additive, at least one rheology-controlling agent, at least one solvent, or any combination thereof; and

(b) the second component comprises at least one peroxide compound. The coating composition and the resin itself can be used as components for a stain, a primer, a sealer, a topcoat, and the like.

### DETAILED DESCRIPTION OF THE INVENTION

This invention relates to the preparation of highly-branched, allyl ether-functionalized, unsaturated polyester resins and their utility in the formulation of coating compositions. Generally, the synthesis of the highly-branched, allyl ether-functionalized, unsaturated polyester resins can be carried out in two steps. The first preparative step is to synthesize a hydroxyl-functionalized, allyl ether-functionalized, unsaturated polyester, which is optionally carboxyl-functionalized. The second preparative step is to react the hydroxyl-functionalized, allyl ether-functionalized, unsaturated polyester from the first step with a polyisocyanate, an isocyanate prepolymer, or a combination thereof, to afford a highly-branched, allyl ether-functionalized, unsaturated polyester resin. The resulting resins can be used to formulate solvent-borne coating compositions, particularly two component coating compositions, in which the compositions are formaldehyde-free, styrene-free, and isocyanate-free. These two component coating compositions are capable of curing quickly at comparatively low temperatures.

### Highly-Branched, Allyl Ether-Functionalized, Unsaturated Polyesters (HBAUP)

In one aspect, this disclosure provides for a resin composition comprising the contact product of:

(a) a hydroxyl-functionalized, allyl ether-functionalized, optionally carboxyl-functionalized, unsaturated polyester (abbreviated AUP); and

(b) a polyisocyanate, an isocyanate prepolymer, or a combination thereof;

in which the contact product can comprise a highly-branched, allyl ether-functionalized, unsaturated polyester (abbreviated HBAUP) as described herein.

Unless otherwise specified, reference simply to a polyester, an unsaturated polyester, or a functionalized polyester according to this invention is intended to refer to component (a) above, that is, it is intended to refer to the unsaturated polyester that is hydroxyl-functionalized, allyl ether-functionalized, and optionally carboxyl-functionalized. However, reference to the “highly-branched” polyester or the highly-branched, unsaturated polyester of this invention, unless otherwise specified, is intended to refer to the allyl ether-functionalized, unsaturated polyester resinous material that results upon contacting components (a) and (b) above that is more highly branched than component (a). Thus, while there can be branching in the unsaturated polyester of component (a) above, the contact product of components (a) and (b) is more highly-branched than component (a) alone, and is accordingly termed a “highly-branched” polyester. In another aspect, the term “highly-branched” refers to a resin that forms from contacting a hydroxyl-functionalized, allyl ether-functionalized, optionally carboxyl-functionalized, unsaturated polyester (component (a)) with a polyisocyanate in a molar ratio selected such that there is at least one reactive hydroxyl group from the unsaturated polyester component per isocyanate functional group from the polyisocyanate component, thereby forming a highly-branched, unsaturated polyester as disclosed herein.

A further aspect of this invention is provided in the preparation of the hydroxyl-functionalized, allyl ether-functionalized, optionally carboxyl-functionalized, unsaturated polyester, which is used to prepare the contact product of the functionalized, unsaturated polyester and the polyisocyanate or isocyanate prepolymer. In this aspect, the functionalized, unsaturated polyester can be prepared by at least two different ways. First, the unsaturated polyester can be prepared by contacting: (i) an acid-functionalized, unsaturated polyester prepolymer; and (ii) a hydroxyl-functionalized, optionally carboxyl-functionalized allyl ether, in which the unsaturated polyester prepolymer is condensed with the functionalized allyl ether. In this synthetic method, the acid-functionalized, unsaturated polyester prepolymer can be generated by contacting a polyacid, an anhydride, or any combination thereof with a polyol. Second, the unsaturated polyester can be prepared by contacting, at substantially the same time: (i) a polyacid, an anhydride, or any combination thereof; (ii) a polyol; and (iii) a hydroxyl-functionalized, optionally carboxyl-functionalized, allyl ether. Regardless of which synthetic method is employed, the same fundamental synthetic components, such as polyacids, anhydrides, polyols, functionalized allyl ethers, and the like, can be used.

Examples of polyacids and anhydrides that can be used in either preparative method described above include, but are not limited to, maleic acid, fumaric acid, phthalic acid, 5-nitroisophthalic, isophthalic acid, terephthalic acid, nitroterephthalic, itaconic acid, oxalic acid, malonic acid, succinic acid, 2-methyl butanedioic acid, glutaric acid, adipic acid, citric acid, 2,4-dimethyl hexanedioic acid, pimelic acid, suberic acid, azelaic acid, sebacic acid, 5-norbornene-2,3-di-carboxylic acid, mesaconic acid, citraconic acid, chloromaleic acid, naphthalene dicarboxylic, 1,2,3-benzenetricarboxylic, 1,2,4-benzenetricarboxylic acid, an anhydride thereof, and the like, including any combination thereof. Moreover, anhydrides that, are useful in either synthetic method include, but are not limited to, maleic anhydride (MA), phthalic anhydride (PA), tetrahydrophthalic anhydride, hexahydrophthalic anhydride, methylhexahydrophthalic anhydride, succinic anhydride, glutaric anhydride, β-methylglutaric anhydride, chlorendic anhydride, and the like, including any combination thereof.

Suitable polyols that can be employed in either preparative method include, but are not limited to, ethylene glycol (EG), propylene glycol (PG), 1,2-propanediol, 1,3-propanediol, 1,4-butanediol, 1,5-pentanediol, 1,6-hexanediol, diethylene glycol, dipropylene glycol, triethylene glycol, tetraethylene glycol, neopentyl glycol, 2,2,4-trimethyl-1,3-pentanediol, cyclohexanediol, cyclohexanedimethanol, 2,2-dimethyl-3-hydroxypropyl-2,2-dimethyl-3-hydroxypropionate, bisphenol, 1,3-butylethylpropanediol, 2-methyl-1,3-propanediol, cyclohexanedimethanol, glycerol, pentaerythritol, trimethylolethane, trimethylolpropane, tripropylene glycol, 1,4-benzyldimethanol, 1,4-benzyldiethanol, 2,4-dimethyl-2-ethylhexane-1,3-diol, glycerol 1,4-cyclohexanediethanol, hydroquinone, phenylenedimethanol, resorcinol, naphthalenediol, anthracene-1,10-diol, 1,3,5-tris(2-hydroxyethyl cyanuric acid), and the like, including any combination thereof.

Further, suitable hydroxyl-functionalized, optionally carboxyl-functionalized, allyl ethers that are synthetically useful in either preparative method include, but are not limited to hydroxyl-functionalized, optionally carboxyl-functionalized, allyl ether compounds that contain two or more hydroxyl groups per molecule. In a further aspect, suitable hydroxyl-functionalized, optionally carboxyl-functionalized, allyl ethers include, but are not limited to hydroxyl-functionalized, optionally carboxyl-functionalized, allyl ether compounds that contain one or more hydroxyl groups per molecule. In still another aspect, suitable hydroxyl-functionalized, optionally carboxyl-functionalized, allyl ether species that can be used include, but are not limited to, trimethylolpropane diallyl ether (TMPDE), trimethylolpropane monoallyl ether (TMPME), glycerol diallyl ether, glycerol monoallyl ether, pentaerythritol diallyl ether, pentaerythritol monoallyl ether, and the like, including any combination thereof.

Specific preparative examples of the resin composition that comprises the hydroxyl-functionalized, allyl ether-functionalized, optionally carboxyl-functionalized, unsaturated polyester include a resin material that is prepared by contacting, at substantially the same time:

(a) maleic anhydride (MA), phthalic anhydride (PA), or a combination thereof;

(b) ethylene glycol (EG), propylene glycol (PG), or a combination thereof; and

(c) trimethylolpropane diallyl ether (TMPDE), trimethylolpropane monoallyl ether (TMPME), or a combination thereof.

Thus, for example, the hydroxyl-functionalized, allyl ether-functionalized, optionally carboxyl-functionalized, unsaturated polyester can be prepared by contacting, at substantially the same time, maleic anhydride (MA), phthalic anhydride (PA), ethylene glycol (EG), propylene glycol (PG), and trimethylolpropane diallyl ether (TMPDE).

In a further aspect, according to the first synthetic scheme, components (a) and (b) immediately above can be contacted to form an acid-functionalized, unsaturated polyester prepolymer, which is then contacted with component (c) disclosed immediately above, thereby providing the hydroxyl-functionalized, allyl ether-functionalized, optionally carboxyl-functionalized, unsaturated polyester. Whether the unsaturated polyester is carboxyl-functionalized can be determined by, among other things, the relative molar ratios of the components provided, as understood by the skilled artisan.

As disclosed, the synthesis of the highly-branched, allyl ether-functionalized, unsaturated polyester resins can be carried out in two steps: the preparation of a hydroxyl-functionalized, allyl ether-functionalized, unsaturated polyester, which is also optionally carboxyl-functionalized; and the reaction of this functionalized, unsaturated polyester with a polyisocyanate, an isocyanate prepolymer, or a combination thereof. Use of the term polyisocyanate is intended to encompass diisocyanates and triisocyanates, as well as any more highly functionalized multi-isocyanate compounds. Examples of suitable polyisocyanates and the isocyanate prepolymers include, but are not limited to, isophorone diisocyanate (IPDI), trimethylhexamethylene diisocyanate, 1,6-hexamethylene diisocyanate (HDI), 4,4′-methylene-bis(cyclohexyl isocyanate), 2,4-toluene diisocyanate, 2,6-toluene diisocyanate, methylene diphenyl diisocyanate (MDI), 4,4′,4″-triphenylmethane triisocyanate, toluene-2,4,6-tri-isocyanate, 4-isocyanate methyl-1,8-octamethylene diisocyanate, 4,4′-dimethyldiphenyl-methane-2,2′,5,5′-tetra-isocyanate, any combination thereof any prepolymer thereof, or a prepolymer of any mixture thereof.

In a further aspect, this invention affords a method of preparing a resin composition, comprising contacting a first component, a second component, and optionally, a third component, wherein:

(a) the first component is prepared by:
(i) contacting:
   (A) an acid-functionalized, unsaturated polyester prepolymer; and
   (B) a hydroxyl-functionalized, optionally carboxyl-functionalized allyl ether; or
(ii) contacting, at substantially the same time,
   (A) a polyacid, an anhydride, or any combination thereof;
   (B) a polyol;
   (C) a hydroxyl-functionalized, optionally carboxyl-functionalized, allyl ether; and

(b) the second component comprises a polyisocyanate, an isocyanate prepolymer, or a combination thereof; and

(c) the optional third component comprises at least one catalyst, at least one solvent, or a combination thereof.

When the first component disclosed immediately above is prepared by contacting an acid-functionalized, unsaturated polyester prepolymer (component A), with a hydroxyl-functionalized, optionally carboxyl-functionalized allyl ether (component B), the following weight percentages of components A and B can be contacted. In one aspect, from about 40 wt % to about 95 wt % of component A can be contacted with from about 60 wt % to about 5 wt % of component B. In another aspect, from about 50 wt % to about 80 wt % of component A can be contacted with from about 50 wt % to about 20 wt % of component B. Further, from about 60 wt % to about 80 wt % of component A can be contacted with from about 40 wt % to about 20 wt % of component B.

When the first component disclosed immediately above is prepared by contacting at substantially the same time, a poly acid, an anhydride, or any combination thereof (component A), a polyol (component B), and a hydroxyl-functionalized, optionally carboxyl-functionalized, allyl ether (component C), the following weight percentages of components A, B, and C can be contacted. In one aspect, from about 10 wt % to about 60 wt % of component A, from about 10 wt % to about 60 wt % of component B, and from about 10 wt % to about 60 wt % of component C can be contacted at substantially the same time. In another aspect, from about 20 wt % to about 50 wt % of component A, from about 20 wt % to about 50 wt % of component B, and from about 20 wt % to about 50 wt % of component C can be contacted at substantially the same time. In a further aspect, from about 20 wt % to about 40 wt % of component A, from about 20 wt % to about 40 wt % of component B, and from about 30 wt % to about 50 wt % of component C can be contacted at substantially the same time.

In a further aspect, this invention affords a method of preparing a resin composition, comprising contacting a first component, a second component, and optionally, a third component, wherein:

(a) the first component is prepared by:
i) contacting: (A) an acid-functionalized, unsaturated polyester prepolymer; and (B) a hydroxyl-functionalized, optionally carboxyl-functionaiized allyl ether;

In a further aspect, the resin composition itself can also comprise the contact product of:

(a) a hydroxyl-functionalized, allyl ether-functionalized, optionally carboxyl-functionalized, un saturated polyester;

(b) a polyisocyanate, an isocyanate prepolymer, or a combination thereof; and

(c) optionally, at least one catalyst, at least one solvent, or a combination thereof.

In this aspect, when the hydroxyl-functionalized, allyl ether-functionalized, optionally carboxyl-functionalized, unsaturated polyester is component A; the polyisocyanate, an isocyanate prepolymer, or a combination thereof is component B; and the optional at least one catalyst, at least one solvent, or a combination thereof is component C, the following weight percentages of components A, B, and C can be contacted. In one aspect, from about 75 wt % to about 99.9 wt % of component A, up to about 25 wt % of component B, and from about 0 wt % to about 2 wt % of component C can be contacted. In another aspect, from about 80 wt % to about 99.5 wt % of component A, up to about 20 wt % of component B, and from about 0 wt % to about 1.5 wt % of component C can be contacted. Moreover, in yet another aspect, from about 85 wt % to about 99.5 wt % of component A, up to about 15 wt % of component B, and from about 0 wt % to about 1.2 wt % of component C can be contacted. In a further aspect, from about 90 wt % to about 99 wt % of component A, from about 1 wt % to about 10 wt % of component B, and from about 0 wt % to about 1 wt % of component C can be contacted at substantially the same time. This contact product can comprise a highly-branched, allyl ether-functionalized, unsaturated polyester as described herein.

Regarding the optional catalyst and the optional solvent, examples of catalysts include, but are not limited to, dialkyl tin carboxylates, dialkyl tin alkoxides, dialkyl tin thiolates, dialkyl tin halides, tertiary amines, and similar compounds. Specific examples of suitable catalysts include dibutyl tin dilaurate, dibutyl tin di[(3-thiopropyl)-trimetlioxysilane], dibutyl tin-β-mercaptopropionate, dibutyitin dichloride, dibutyl tin maleate, 1,4-diazabicyclo[2,2,2]octane, or any combination thereof.

Examples of suitable solvents include, but are not limited to, solvents that are also useful in the preparation of the coating composition itself including, but not limited to, at least one solvent selected from a hydrocarbon solvent, an aromatic solvent, an ester solvent, a ketone solvent, or any combination thereof. In this aspect, the at least one solvent can be selected from petroleum ether, ligroin, VM&P (Varnish Makers and Painter's) naphtha, mineral spirits, xylene, toluene, mesitylene, methyl acetate, propyl acetate, butyl acetate, acetone, methyl ethyl ketone (MEK), or any combination thereof.

### Coating Compositions

A further aspect of this disclosure provides a coating composition comprising the contact product of a first component and a second component. The first component comprises the highly-branched, allyl ether-functionalized, unsaturated polyester resin disclosed herein. The first component can include acrylic- or acrylate-functionalized co-reactants, resin modifiers such as thermoplastic resin modifiers, coating additives, pigments, colorants, fillers, metal driers, waxes, surface active additives, rheology controlling agents, solvents, and the like, although these components are not required ingredients of the first component. For example, the first component can include polyacrylates and/or polymethylacrylates, polyethylene glycol acrylates or methylacrylates, and/and other acrylic- or acrylate-functionalized co-reactants. The second component typically comprises a peroxide compound, including an organic peroxide or a mixture of organic peroxides. Thus, in this aspect, the coating composition can comprise the contact product of a first component and an optional second component, wherein:

(a) the first component comprises the contact product of:
(i) a highly-branched, allyl ether-functionalized, unsaturated polyester resin;
(ii) optionally, a polyacrylate, a polymethylacrylate, a polymethyl methacrylate, a polyethylene glycol acrylate, a polyethylene glycol methylacrylate, a polyethylene glycol methyl methacrylate, or any combination thereof, and
(iii) optionally, at least one thermoplastic resin modifier, at least one metal drier, at least one pigment, at least one filler, at least one wax, at least one colorant, at least one surface active additive, at least one rheology-controlling agent, at least one solvent, or any combination thereof; and

(b) the optional second component comprises at least one peroxide compound.

The coating composition and the resin itself can be used as components for a stain, a primer, a sealer, a topcoat, and the like. Moreover, the coating composition can cure without the peroxide compound second component, thus the second component comprising at least one peroxide compound is optional. By describing the coating composition as comprising the contact product of a first component and an optional second component, it is intended to reflect that the coating composition can comprise either the contact product of the first component and the second component, or the coating composition can comprise the recited first component only. This same convention is intended when the first component is described as comprising the contact product of a highly-branched, allyl ether-functionalized, unsaturated polyester resin and certain optional components, that is, when the first component includes no optional components, then the “contact product” constitutes merely the highly-branched, allyl ether-functionalized, unsaturated polyester resin as recited.

Further to this aspect, the coating composition of this disclosure can comprise the contact product of a first component and a second component, wherein:

a) the first component comprises the contact product of:
(i) a highly-branched, allyl ether-functionalized, unsaturated polyester resin;
(ii) at least one(meth)acrylic-functionalized monomer or poly(meth)acrylate; and
(iii) at least one metal drier; and

(b) the second component comprises at least one peroxide compound.

When the first component of the coating composition comprising the highly-branched, allyl ether-functionalized, unsaturated polyester resin, is mixed or combined with the second component comprising a peroxide compound, a wide range of ratios of first component to second component can be utilized. For example, the volume ratio of first component to second component can range from about 100:0.1 to about 100:20 by volume. Typically, the volume ratio can range from about 100:0.5 to about 100:10 by volume, or about 100:1 to about 100:5 by volume. Mixing can be accomplished in any manner known in the art, including mixing in a plural component spray gun system combines the two components prior to or during application of the coating composition. Further, weight ratios of highly-branched, allyl ether-functionalized, unsaturated polyester resin-to-peroxide compound that are particularly useful include, but are not limited to, from about 100:0.1 to about 100:15, from about 100:0.2 to about 100:10, or from about 100:0.5 to about 100:5. These latter ratios are based on the weight ratios of the highly-branched unsaturated polyester resin to the peroxide compound.

The coating compositions of this disclosure can be utilized without thermoplastic resin modifiers if so desired, or the coating compositions optionally can comprise at least one thermoplastic resin modifier. The optional at least one thermoplastic resin modifier can be selected from any thermoplastic resin modifier known in the art, including, but not limited to, a polyacrylate, a polymethylacrylate, a polymethyl methacrylate, a polyethylene glycol acrylate, a polyethylene glycol methylacrylate, a polyethylene glycol methyl methacrylate, a polyvinyl, a cellulose acetate, a cellulose acetate butyrate, a nitrocellulose, or any combination thereof.

In one aspect, the coating compositions of this disclosure can be utilized without metal driers if desired, or the coating compositions optionally can comprise at least one metal driers. Examples of the optional at least one metal drier can be selected from a compound of Co, Mn, Pb, Ce, Zr, Ca, Zn, Bi, Cu, Cr, Li, K, Rb, Ni, or any combination thereof. For example, suitable metal driers can be selected from a carboxylate, a naphthenate, or a fatty acid compound of Co, Mn, Pb, Ce, Zr, Ca, Zn, Bi, Cu, Cr, Li, K, Rb, Ni, or any combination thereof.

Still a further aspect provides that the coating composition of this disclosure cars be utilized as clear compositions without pigments, or the coating compositions optionally can comprise at least one pigment. Suitable pigments that can be used in this invention are any pigment that is compatible with the coating composition, examples of which include, but are not limited to the following:

a) inorganic pigments, including but not limited to, silicon oxide, titanium oxide, aluminum oxide, tin oxide, zinc oxide, iron oxide, calcium carbonate, barium sulfate, magnesium-aluminum silicate, calcium-aluminum silicate, glass beads, any hydrate thereof, or any combination thereof;

b) organic and other carbon-containing pigments or solid particles, including but not limited to, cross-linked SBR latexes, micronized polyethylene wax, micronized polypropylene wax, acrylic beads, methacrylic beads, azo pigments, azo lake pigments, condensed azo pigments, chelate azo pigments, phthalocyanine pigments, anthraquinone pigments, perylene pigments, perynone pigments, thioindigo pigments, quinachrydone pigments, dioxazine pigments, isoindolinone pigments, quinophthalone pigments, vat lake pigments, azine pigments, nitroso pigments, nitro pigments, carbon black, natural pigments, fluorescent pigments, or any combination thereof; and

c) metal pigments, including but not limited to, selected from copper, aluminum, bronze, brass, tin, zinc, silver, gold, titanium, zirconium, tin, iron, steel, alloys thereof, mixtures thereof, or any combination thereof.

Further, the coating compositions of this disclosure can be utilized without fillers if desired, or the coating compositions optionally can comprise at least one filler. Examples of the optional at least one filler include, but are not limited to, talc, clay, and the like, or a combination thereof.

Another aspect of this disclosure provides that the coating composition can be utilized without colorants if desired, or the coating compositions optionally can comprise at least one colorant. Suitable colorants include, but are not limited to: organic dyes; inorganic colorants, such as yellow oxide, red oxides, and the like; organic colorants; or any combination thereof.

In another aspect of this invention, the coating compositions can be utilized without surface active or flow/leveling agents if desired, or the coating compositions optionally can comprise surface active agents. Examples of the optional at least one surface active additive include, but are not limited to: silicones such as BYK™ 306, BYK™ 333, or BYK™ 348; or non-silicone products such as polyacylates, for example BYK™ 380 or BYK™ 353; or any combination thereof.

In still another aspect, the coating composition of this disclosure can be utilized without rheology-controlling agents if desired, or the coating compositions optionally can comprise at least one rheology-controlling agent. Examples of the optional at least one rheology-controlling agent include, but are not limited to a bentonite, a fumed silica, a polyurea, a polyamide, or any combination thereof.

Still a further aspect provides that the coating composition of this disclosure can be utilized without solvents, or the coating compositions optionally can comprise at least one solvent. Thus, the optional at least one solvent can be selected from a hydrocarbon solvent, an aromatic solvent, as ester solvent, a ketone solvent, or any combination thereof. In this aspect the at least one solvent can be selected from petroleum ether, ligroin, VM&P (Varnish Makers and Painter's) naphtha, mineral spirits, xylene, toluene, mesitylene, methyl acetate, propyl acetate, butyl acetate, isobutyl acetate, acetone, methyl ethyl ketone (MEK), or any combination thereof.

The disclosed coatings compositions are substantially formaldehyde-free, styrene-free, and isocyanate-free, two component coating compositions that are capable of curing quickly at comparatively low temperatures. By the term substantially formaldehyde-, styrene-, and isocyanate-free, it is intended to refer to the prepared coating composition that is characterized by having amounts of free and emitted formaldehyde, styrene, and isocyanate levels that are less than or equal to about 100 ppm, less than or equal to about 50 ppm, or less than or equal to about 10 ppm, based on the weight of the prepared coating composition.

These two component coating compositions are capable of curing quickly at comparatively low temperatures, with or without the presence of the organic peroxides. Thus, when curing is conducted in the presence of a peroxide compound, these coatings can cure at a relatively low temperature. The curing times disclosed herein refer to the time required to obtain a tacky-free film following application of the coating composition, in which the two components were mixed and immediately thereafter applied to the substrate or surface. In this aspect, for example, these coatings can cure in less than or equal to about 10 minutes to afford water-white films at a temperature less than or equal to about 75° C., less than or equal to about 60° C., less than or equal to about 55° C., less than or equal to about 50° C., or less than or equal to about 45° C. In another aspect, for example, the present coatings can cure in less than or equal to about 15 minutes at a temperature less than or equal to about 65° C., less than or equal to about 60° C., less than or equal to about 55° C., less than or equal to about 50° C., less than or equal to about 45° C., or less than or equal to about 40° C. For example, the coating composition according to this disclosure can be cured in less than or equal to about 10 minutes at a temperature of less than or equal to about 50° C. If curing at room temperature is desired, these coatings can cure at around room temperature in less than or equal to about 18 hours, less than or equal to about 15 hours, less than or equal to about 12 hours, or less than or equal to about 10 hours. For example, the coating composition according to this disclosure can be cured at a temperature from about 20° C. to about 25° C. for less than or equal to about 12 hours.

Example 4 and Table 4 provides an evaluation of the curing behavior of specific coating compositions described in Example 3 and Table 3, along with an evaluation of the flexibility of the film formed of the cured coating. For the curing data provided, the curing oven was maintained at 45° C., and the time required to obtain a tacky-free film was recorded. For flexibility measurements, the grading scale used to evaluate the films was arbitrary, with flexibility values above 5 being flexible and below 5 being brittle.

The resins and the coatings compositions prepared from these resins can be used to formulate stains, primers, sealers, topcoats, and the like, and can be used to finish a wide variety of wood, plastics, and metals, as well as substrates that contain wood, plastics, and metals. Further, the resins and the coatings compositions prepared from these resins can be used to coat wood-, plastic-, and metal-containing substrates for furniture, work surfaces, kitchen cabinets, floors, window frames, doors, sidings, metal, surfaces, and the like.

In one aspect, the coating compositions discloses herein can be used successfully in wood coating applications. Conventional organic peroxide-cured unsaturated coating systems generally have not been successful in the wood coatings industries. These coating systems contain styrene which is a volatile, toxic, and flammable material. When curing is conducted in the absence of styrene, a comparatively higher curing temperature, a longer curing time, or both are required. In the wood coatings industries, curing conditions for the coatings are generally limited at about 130° F. curing temperature for less than about 20 minutes. While faster curing conditions can be attained, these faster curing conditions generally require higher concentrations of cobalt metal driers, which can results in discoloration. In contrast, the present coating compositions are applicable to wood and wood-containing substrates, without being limiting in the manner that conventional organic peroxide cured unsaturated polyester systems are limited. Thus, the present coating system overcomes the curing temperature and curing time limitations, without using styrene and without requiring high concentrations of cobalt metal driers.

The coating compositions of this invention can be applied to a substrate in any manner that is known in the art. For example, in one aspect, the two component coating composition can be mixed and applied using a plural component spray gun system to form a coating film. Mixing can be accomplished prior to or during application of the coating composition, depending on the features of the spray gun. Further, when using a multi-component spray gun, the ratio of first component to second component can range from about 100:0.1 to about 100:20 by volume as disclosed above, including ratios from about 100:0.5 to about 100:10 by volume, or about 100:1 to about 100:5 by volume.

Throughout this disclosure, when Applicants disclose or claim a range of any type, for example a range of temperatures, a weight or volume ratio, or the like. Applicants' intent is to disclose or claim individually each possible number that such a range could reasonably encompass, consistent with the disclosure herein. For example, by the disclosure that a volume ratio of a first component to a second component can be about 100:1 to about 100:5 by volume, Applicants intend to recite that the volume ratio of the first component to the second component can be about 100:1, about 100:2, about 100:3, about 100:4, or about 100:5 by volume. Further, Applicants reserve the right to proviso out or exclude any individual members of such a group, including any sub-ranges or combinations of sub-ranges within the group, that can be claimed according to a range or in any similar manner, if for any reason Applicants choose to claim less than the full measure of the disclosure, for example, to account for a reference that Applicants are unaware of at the time of the filing of the application.

Although methods, syntheses, and materials similar or equivalent to those described herein can be used in the practice or testing of this invention, typical methods, syntheses, and materials are described herein. General references related to polyester coating technology include U.S. Pat. Nos. 4,163,093 and 4,760,111.

The present invention is further illustrated by the following examples, which are not to be construed in any way as imposing limitations upon the scope thereof. On the contrary, it is to be clearly understood that resort may be had to various other aspects, embodiments, modifications, and equivalents thereof which, after reading the description herein, may suggest themselves to one of ordinary skill in the art without departing from the spirit of the present invention or the scope of the appended claims.

### EXAMPLES

The BYK™ components used in these examples are poly(alkylene oxide)-modified poly(dimethyl siloxane), and are available from Byk Chemie. The Roskydal 502 BA unsaturated polyester, Desmodur N3400, Desmodur XP2410 were obtained from Bayer Material Science. Desmodur N3400 and Desmodur XP2410 are a low-viscosity, solvent-free aliphatic polyisocyanate based on hexamethylene diisocyanate. Unless otherwise specified, other reagents, catalysts, solvents, and the like that were employed in these examples were obtained from standard commercial sources. Acid number was measured and reported in the usual way, as the number of milligrams of potassium hydroxide (KOH) neutralized by the free acid present in one gram of the test substance, and is a measure of the free carboxylic acid content in the test substance. Viscosity was measured using a Gardner Standard Bubble Viscometer according to ASTM D1545. Color was measured using the Gardner Color scale according to ASTM D1544, Standard Test Method for Color of Transparent Liquids.

### Example 1

### Synthesis of Hydroxyl-Functionalized, Allyl Ether-Functionalized, Optionally Carboxyl-Functionalized, Unsaturated Polyesters (AUP)

Table 1 below provides a listing of specific synthetic components and amounts of these components used to prepare the hydroxyl-functionalized, allyl ether-functionalized, optionally carboxyl-functionalized, unsaturated polyesters of this invention. The polyester identification numbers P1 and P2 are assigned for identification purposes.

TABLE 1
Synthetic Components and Amounts Used to Prepare Unsaturated
Polyesters

| | Component and Amount (grams) | | | | | |
|---|---|---|---|---|---|---|
| | | | | trimethylol | | |
| | | | | propane | trimethylol | |
| Resin | ethylene | propylene | maleic | monoallyl | propane | |
| Sample | glycol | glycol | anhydride | ether | diallyl ether | hydroquinone |
| P1 | 149.0 | 20.5 | 264.8 | 61.0 | 0 | 0.0175 |
| P2 | 118.0 | 16.0 | 255.0 | 0 | 165.0 | 0.0175 |

A. Synthesis Procedure for P1 in One Step. As provided in Table 1, 149.0 g of ethylene glycol, 20.5 g of propylene glycol 264.8 g of maleic anhydride, 61.0 g of trimethylol propane monoallyl ether, and 0.175 grams of a 10% solution of hydroquinone in ethanol, were all charged to a 1.0 liter flask equipped with an agitator, distillation column, condenser, thermometer, and inert gas inlet. This reaction vessel was flushed with inert gas, heated to about 155° C., and maintained at about 155° C. under an inert atmosphere for about one hour as the reaction proceeded. After this time, the reaction temperature was increased to about 175° C. over 3 hours while removing water from the reaction mixture. The batch temperature was held at about 175° C. until an acid number of less than 25 and a viscosity (measured as a 80% solution in butyl acetate) of Z1-Z2 (Gardner Bubble) were achieved. The final acid number was measured as 25.0 and the final viscosity as measured on an 80% solution in butyl acetate was Z2 (Gardner Bubble). The color as measured on the Gardner color scale was 1 and the final resin was free of haze.

B. Synthesis Procedure for P2 in Two Steps. As provided in Table 1, 118.0 g of ethylene glycol, 16.0 g of propylene glycol. 255.0 g of maleic anhydride, and 0.175 grams of a 10% solution of hydroquinone in ethanol, were charged to a 1.0 liter flask equipped with an agitator, distillation column, condenser, thermometer, and inert gas inlet. This reaction vessel was flushed with inert gas, heated to about 180° C., and maintained at about 180° C. under an inert atmosphere for about one hour as the reaction proceeded. After this time, the reaction temperature was increased to about 210° C. over 2 hours while removing water from the reaction mixture. The batch temperature was held at about 210° C. until an acid number of less than 70 was achieved. The batch temperature was then lowered to about 150° C., after which 0.77 mole of trimethylol propane diallylether was added to the reaction vessel. The temperature was then increased to 175° C. over 1 hour while removing water from the reaction mixture. The batch temperature was held at 175° C. until an acid number of less than 25 and a viscosity (measured as a 80% solution in butyl acetate) of S (Gardner) were achieved. The final acid number was measured as 24.5 and the final viscosity as measured on a 72.8% solution in butyl acetate was S-T (Gardner Bubble). The color as measured on the Gardner color scale was 1 and the resin was free of haze.

### Example 2

### Synthesis of Highly-Branched, Allyl Ether-Functionalized, Unsaturated Polyester Resins (HBAUP)

The synthesis of the highly branched, allyl ether functionalized unsaturated polyester resins (HBAUP) were carried out through the reaction of isocyanate functional groups from polyisocyanate compounds with hydroxyl groups from polyol compounds using conventional methods. For example, conventional methods are disclosed in U.S. Pat. Nos. 4,328,325 and 5,859,131. The following reagents were used to prepare the highly-branched, allyl ether-functionalized, unsaturated polyester resins of this invention. Allyl ether functionalized unsaturated polyester resins P1 and P2 from Example 1 and the commercially available unsaturated polyester resin Roskydal 502 BA (R502) were employed. Commercially available Desmodur XP2410 and Desmodur N3400 aliphatic and aromatic polyisocyanates, respectively, were used. Mondur MR Light polyol and a tine catalyst, typically dibutyl tin dilauratem were also used in the preparation of these resins.

Table 2 below provides a listing of specific synthetic components and amounts used to prepare the highly-branched, allyl ether-functionalized, unsaturated polyester resins of this invention. The synthetic details follow.

TABLE 2
Synthetic Components and Amounts Used to Prepare Resins

| | Component and Amount (grams) | | | |
|---|---|---|---|---|
| | Polyester, | | | |
| Resin | g | Isocyanate, g | Catalyst, g | Solvent, g |
| R1 | R502, 200 | Desmodur N3400, | Dibutyl tin | Butyl acetate, |
| | | 8.79 | dilaurate, 0.20 | 53.51 |
| R2 | R502, 200 | Desmodur N3400, | Dibutyl tin | Butyl acetate, |
| | | 11.72 | dilaurate, 0.20 | 54.26 |
| R3 | R502, 200 | Desmodur N3400, | Dibutyl tin | Butyl acetate, |
| | | 14.65 | dilaurate, 0.20 | 55.00 |
| R4 | R502, 200 | Desmodur XP2410, | Dibutyl tin | Butyl acetate, |
| | | 4.29 | dilaurate, 0.20 | 52.36 |
| R5 | R502, 200 | Desmodur XP2410, | Dibutyl tin | Butyl acetate, |
| | | 5.72 | dilaurate, 0.20 | 52.72 |
| R6 | R502, 200 | Desmodur XP2410, | Dibutyl tin | Butyl acetate, |
| | | 7.15 | dilaurate, 0.20 | 53.09 |
| R7 | R502, | Desmodur XP2410, | Dibutyl tin | Butyl acetate, |
| | 1875 | 84 | dilaurate, 1.75 | 150 |
| R8 | P1, 200 | Mondur MR Light, | Dibutyl tin | Butyl acetate, |
| | | 4.58 | dilaurate, 0.2 | 51.18 |
| R9 | P2, 200 | Mondur MR Light, | Dibutyl tin | Butyl acetate, |
| | | 4.58 | dilaurate, 0.2 | 51.18 |

A. Low Temperature Synthesis Procedure for R1 through R6, R8, and R9. The highly-branched, allyl ether-functionalized, unsaturated polyester resins R1 through R6, R8, and R9 were prepared by charging the ingredients listed in Table 2 into a reaction vessel at a room temperature. The reaction vessel was equipped to control temperature, stirring or agitation, and the atmosphere under which the reaction was conducted. Reactions were conducted under typical isocyanate-hydroxyl reaction conditions, for example, reactions could he carried out at about 50° C. for about 24 hours to provide the desired resin.

B. High Temperature Synthesis Procedure for R7. 1875 grams of Roskydal 502 BA (% NVM=80 allyl ether functional unsaturated polyester resin in butyl acetate), 150 grams of butyl acetate, and 1.75 grams of dibutyltin dilaurate were charged to a 3.0 liter flask equipped with an agitator, condenser, thermometer, and inert gas inlet. The reactor was flushed with inert gas and the reaction mixture heated to about 50° C. The reactor was held at about 50° C., while 84 grams of Desmodur XP2410 was slowly added over 30 minutes. The reaction temperature was then increased to about 85° C., over 1 hour and held at about 85° C. until no NCO functionality was detected by FTIR. After this time, 150 grams of n-propanol was added and the mixture was maintained at about 85° C. for an additional 2 hours to consume any unreacted isocyanate NCO groups. The final viscosity was X½ (Gardner-Bubble) and the final color as measured on the Gardner color scale was 1 and the resin was free of haze.

Following reaction, the resulting resin products were then used in the preparation of the coating compositions as detailed in the example below.

### Example 3

### Preparation of Coating Composition's Containing Highly-Branched, Allyl Ether-Functionalized, Unsaturated Polyester Resins (HBAUP)

Table 3 below provides a listing of specific coating composition components and amounts used to prepare the coating compositions containing highly-branched, allyl ether-functionalized, unsaturated polyester resins listed in Table 2. Thus, the coating composition identification numbers C1 through C9 in Table 3 correspond to the highly-branched resin numbers R1 through R9 from Table 2.

General formulation details are as follows. The coating formulations were prepared by adding, sequentially, the specified amounts of ingredients in the order provided in Table 3, under agitation or stirring conditions. Thus, the First Component ingredients were combined in the order shown, followed by the Second Component ingredients, to provide the coating compositions C1 through C9. For comparative purposes, coating composition C10 to C12 are prepared using the unsaturated polyester resins that are not highly branched, that is, resins have not been condensed using a polyisocyanate or an isocyanate prepolymer.

TABLE 3
Components and Amount Used to Prepare the Coating Compositions

| Ingredient | C1 | C2 | C3 | C4 | C5 | C6 | C7 | C8 | C9 | C10 | C11 | C12 |
|---|---|---|---|---|---|---|---|---|---|---|---|---|
| | First Component Coating Composition, g | | | | | | | | | | | |
| HBAUP | R1, | R2, | R3, | R4, | R5, | R6, | R7, | R8, | R9, | — | — | — |
| | 95.0 | 95.0 | 95.0 | 95.0 | 95.0 | 95.0 | 81.51 | 95.0 | 95.0 | | | |
| AUP | — | — | — | — | — | — | — | — | — | R502, | P1, | P2, |
| | | | | | | | | | | 76.42 | 76.42 | 76.42 |
| Butyl | 24.7 | 24.7 | 24.7 | 24.7 | 24.7 | 24.7 | 38.19 | 43.28 | 24.7 | 43.28 | 24.7 | 43.28 |
| acetate | | | | | | | | | | | | |
| MEK | 15.0 | 15.0 | 15.0 | 15.0 | 15.0 | 15.0 | 15.0 | 15.0 | 15.0 | 15.0 | 15.0 | 15.0 |
| BYK ™ | 0.2 | 0.2 | 0.2 | 0.2 | 0.2 | 0.2 | 0.2 | 0.2 | 0.2 | 0.2 | 0.2 | 0.2 |
| 380 | | | | | | | | | | | | |
| BYK ™ | 0.2 | 0.2 | 0.2 | 0.2 | 0.2 | 0.2 | 0.2 | 0.2 | 0.2 | 0.2 | 0.2 | 0.2 |
| 348 | | | | | | | | | | | | |
| BYK ™ | 0.1 | 0.1 | 0.1 | 0.1 | 0.1 | 0.1 | 0.1 | 0.1 | 0.1 | 0.1 | 0.1 | 0.1 |
| 353 | | | | | | | | | | | | |
| Syn Nuxtra | 0.4 | 0.4 | 0.4 | 0.4 | 0.4 | 0.4 | 0.4 | 0.4 | 0.4 | 0.4 | 0.4 | 0.4 |
| Cobalt 12 | | | | | | | | | | | | |
| Syn Nuxtra | 0.3 | 0.3 | 0.3 | 0.3 | 0.3 | 0.3 | 0.3 | 0.3 | 0.3 | 0.3 | 0.3 | 0.3 |
| Mg 12 | | | | | | | | | | | | |
| Syn Nuxtra | 0.3 | 0.3 | 0.3 | 0.3 | 0.3 | 0.3 | 0.3 | 0.3 | 0.3 | 0.3 | 0.3 | 0.3 |
| K 15 | | | | | | | | | | | | |
| Xylene | 1 | 1 | 1 | 1 | 1 | 1 | 1 | 1 | 1 | 1 | 1 | 1 |
| | Second Component Coating Composition, g | | | | | | | | | | | |
| Norox ® | 4.1 | 4.1 | 4.1 | 4.1 | 4.1 | 4.1 | 4.1 | 4.1 | 4.1 | 4.1 | 4.1 | 4.1 |
| MEKP-9 | | | | | | | | | | | | |

### Example 4

### Coating Composition Curing Time and Flexibility

Table 4 below provides an evaluation of each specific coating composition, as tested for curing time and for flexibility of the resulting film. The first component of the composition, provided according to Example 3 and Table 3, was mixed with the second component of the coating composition, namely, 4.1 g of Norox® MEKP-9. The resulting formulation was drawn down 3 wet mils on the white Leneta charts and air flash dried for 15 minutes at room temperature. The coated charts were then placed in an oven maintained at 45° C. to evaluate the curing performance, and the time required to obtain a tacky-free film was recorded. In addition, the flexibility of the resulting films was also tested and is summarized in Table 4. For flexibility measurements, the grading scale used to evaluate the films was arbitrary, with flexibility values above 5 being flexible and below 5 being brittle.

TABLE 4
Coating Composition Curing Performance

| Coating | | |
|---|---|---|
| Composition | Curing Time, min | Flexibility^{A} |
| C1 | 8.0 | 6 |
| C2 | 6.0 | 6 |
| C3 | 5.5 | 5 |
| C4 | 7.0 | 5 |
| C5 | 5.0 | 5 |
| C6 | 4.0 | 4 |
| C7 | 6.0 | 5.5 |
| C8 | 7.0 | 6.0 |
| C9 | 12.0 | 7.0 |
| C10 | 10.0 | 5 |
| C11 | 12.0 | 5.5 |
| C12 | 27.0 | 6 |

^{A}The flexibility grading scale is arbitrary, with flexibility values above 5 being flexible and below 5 being brittle

We claim:

1. A resin composition comprising the contact product of:
(a) a hydroxyl-functionalized, allyl ether-functionalized, optionally carboxyl-functionalized, unsaturated polyester; and
(b) a polyisocyanate, an isocyanate prepolymer, or a combination thereof.

2. The resin composition according to claim 1, wherein the contact product comprises a highly-branched, allyl ether-functionalized, unsaturated polyester.

3. The resin composition according to claim 1, wherein the polyisocyanate and the isocyanate prepolymer are selected independently from isophorone diisocyanate (IPDI), trimethylhexamethylene diisocyanate, 1,6-hexamethylene diisocyanate (HDI), 4,4′-methylene-bis(cyclohexyl isocyanate), 2,4-toluene diisocyanate, 2,6-toluene diisocyanate, methylene diphenyl diisocyanate (MDI), 4,4′,4″-triphenylmethane triisocyanate, toluene-2,4,6-tri-isocyanate, 4-isocyanate methyl-1,8-octamethylene diisocyanate, 4,4′-dimethyldiphenyl-methane-2,2′,5,5′-tetra-isocyanate, any combination thereof, any prepolymer thereof, or a prepolymer of any mixture thereof.

4. The resin composition according to claim 1, wherein the hydroxyl-functionalized, allyl ether-functionalized, optionally carboxyl-functionalized, unsaturated polyester is prepared by:
(a) contacting
(i) an acid-functionalized, unsaturated polyester prepolymer; and
(ii) a hydroxyl-functionalized, optionally carboxyl-functionalized allyl ether; or
(b) contacting, at substantially the same time,
(i) a polyacid, an anhydride, or any combination thereof;
(ii) a polyol; and
(iii) a hydroxyl-functionalized, optionally carboxyl-functionalized, allyl ether.

5. The resin composition according to claim 4, wherein the polyacid and the anhydride are selected independently from maleic acid, fumaric acid, phthalic acid, 5-nitroisophthalic, isophthalic acid, terephthalic acid, nitroterephthalic, itaconic acid, oxalic acid, malonic acid, succinic acid, 2-methyl butanedioic acid, glutaric acid, adipic acid, citric acid, 2,4-dimethyl hexanedioic acid, pimelic acid, suberic acid, azelaic acid, sebacic acid, 5-norbornene-2,3-di-carboxylic acid, mesaconic acid, citraconic acid, chloromaleic acid, naphthalene dicarboxylic, 1,2,3-benzenetricarboxylic, 1,2,4-benzenetricarboxylic acid, an anhydride thereof, or any combination thereof.

6. The resin composition according to claim 4, wherein the anhydride is selected from maleic anhydride (MA), phthalic anhydride (PA), tetrahydrophthalic anhydride, hexahydrophthalic anhydride, methylhexahydrophthalic anhydride, succinic anhydride, glutaric anhydride, β-methylglutaric anhydride, chlorendic anhydride, or any combination thereof.

7. The resin composition according to claim 4, wherein the polyol is selected independently, from ethylene glycol (EG), propylene glycol (PG), 1,2-propanediol, 1,3-propanediol, 1,4-butanediol, 1,5-pentanediol, 1,6-hexanediol, diethylene glycol, dipropylene glycol, triethylene glycol, tetraethylene glycol, neopentyl glycol, 2,2,4-trimethyl-1,3-pentanediol, cyclohexanediol, cyclohexanedimethanol, 2,2-dimethyl-3-hydroxypropyl-2,2-dimethyl-3-hydroxypropionate, bisphenol, 1,3-butylethylpropanediol, 2-methyl-1,3-propanediol, cyclohexanedimethanol, glycerol, pentaerythritol, trimethylolethane, trimethylolpropane, tripropylene glycol, 1,4-benzyldimethanol, 1,4-benzyldiethanol, 2,4-dimethyl-2-ethylhexane-1,3-diol, glycerol 1,4-cyclohexanediethanol, hydroquinone, phenylenedimethanol, resorcinol, naphthalenediol, anthracene-1,10-diol, 1,3,5-tris(2-hydroxyethyl cyanuric acid), or any combination thereof.

8. The resin composition according to claim 4, wherein the hydroxyl-functionalized, optionally carboxyl-functionalized, allyl ether contains two or more hydroxyl groups per molecule.

9. The resin composition according to claim 4, wherein the hydroxyl-functionalized, optionally carboxyl-functionalized, allyl ether is selected independently from trimethylolpropane diallyl ether (TMPDE), trimethylolpropane monoallyl ether (TMPME), glycerol diallyl ether, glycerol monoallyl ether, pentaerythritol diallyl ether, pentaerythritol monoallyl ether, or any combination thereof.

10. The resin composition according to claim 4, wherein the hydroxyl-functionalized, allyl ether-functionalized, optionally carboxyl-functionalized, unsaturated polyester is prepared by contacting, at substantially the same time:
(a) maleic anhydride (MA), phthalic anhydride (PA), or a combination thereof;
(b) ethylene glycol (EG), propylene glycol (PG), or a combination thereof; and
(c) trimethylolpropane diallyl ether (TMPDE), trimethylolpropane monoallyl ether (TMPME), or a combination thereof.

11. The resin composition according to claim 4, wherein the hydroxyl-functionalized, allyl ether-functionalized, optionally carboxyl-functionalized, unsaturated polyester is prepared by contacting, at substantially the same time, maleic anhydride (MA), phthalic anhydride (PA), ethylene glycol (EG), propylene glycol (PG), and trimethylolpropane diallyl ether (TMPDE).

12. A stain, a primer, a sealer, or a topcoat comprising the resin according to claim 1.

13. A method of preparing a resin composition, comprising contacting a first component, a second component, and optionally, a third component, wherein:
(a) the first component is prepared by:
(i) contacting:
(A) an acid-functionalized, unsaturated polyester prepolymer; and
(B) a hydroxyl-functionalized, optionally carboxyl-functionalized allyl ether; or
(ii) contacting, at substantially the same time,
(A) a polyacid, an anhydride, or any combination thereof;
(B) a polyol;
(C) a hydroxyl-functionalized, optionally carboxyl-functionalized, allyl ether; and
(b) the second component comprises a polyisocyanate, an isocyanate prepolymer, or a combination thereof; and
(c) the optional third component comprises at least one catalyst, at least one solvent, or a combination thereof.

14. A coating composition comprising the contact product of a first component and an optional second component, wherein:
(a) the first component comprises the contact product of:
(i) a highly-branched, allyl ether-functionalized, unsaturated polyester resin;
(ii) optionally, a polyacrylate, a polymethylacrylate, a polymethyl methacrylate, a polyethylene glycol acrylate, a polyethylene glycol methylacrylate, a polyethylene glycol methyl methacrylate, or any combination thereof; and
(iii) optionally, at least one thermoplastic resin modifier, at least one metal drier, at least one pigment, at least one filler, at least one wax, at least one colorant, at least one surface active additive, at least one rheology-controlling agent, at least one solvent, or any combination thereof; and
(b) the optional second component comprises at least one peroxide compound.

15. The coating composition according to claim 14, wherein the at least one thermoplastic resin modifier is selected from a polyacrylate, a polymethylacrylate, a polymethyl methacrylate, a polyethylene glycol acrylate, a polyethylene glycol methylacrylate, a polyethylene glycol methyl methacrylate, a polyvinyl, a cellulose acetate, a cellulose acetate butyrate, or any combination thereof.

16. The coating composition according to claim 14, wherein the at least one metal drier is selected from a compound of Co, Mn, Pb, Ce, Zr, Ca, Zn, Bi, Cu, Cr, Li, K, Rb, Ni, or any combination thereof.

17. The coating composition according to claim 14, wherein the at least one pigment is selected from
a) silicon oxide, titanium oxide, aluminum oxide, tin oxide, zinc oxide, iron oxide, calcium carbonate, barium sulfate, magnesium-aluminum silicate, calcium-aluminum silicate, glass beads, any hydrate thereof, or any combination thereof;
b) cross-linked SBR latexes, micronized polyethylene wax, micronized polypropylene wax, acrylic beads, methacrylic beads, azo pigments, azo lake pigments, condensed azo pigments, chelate azo pigments, phthalocyanine pigments, anthraquinone pigments, perylene pigments, perynone pigments, thioindigo pigments, quinachrydone pigments, dioxazine pigments, isoindolinone pigments, quinophthalone pigments, vat lake pigments, azine pigments, nitroso pigments, nitro pigments, carbon black, natural pigments, fluorescent pigments, or any combination thereof;
c) copper, aluminum, bronze, brass, tin, zinc, silver, gold, titanium, zirconium, tin, iron, steel, alloys thereof, mixtures thereof, or any combination thereof; or
d) any combination thereof.

18. The coating composition according to claim 14, wherein the at least one surface active additive is selected from BYK™ 306, BYK™ 333, BYK™ 348, BYK™ 380, BYK™ 353, or any combination thereof.

19. The coating composition according to claim 14, wherein the at least one rheology-controlling agent is selected from a bentonite, a fumed silica, a polyurea, a polyamide, or any combination thereof.

20. The coating composition according to claim 14, wherein the at least one solvent is selected from a hydrocarbon solvent, an aromatic solvent, as ester solvent, a ketone solvent, or any combination thereof.

21. The coating composition according to claim 14, wherein the at least one solvent is selected from petroleum ether, ligroin, VM&P (Varnish Makers and Painter's) naphtha, mineral spirits, xylene, toluene, mesitylene, methyl acetate, propyl acetate, butyl acetate, isobutyl acetate, acetone, methyl ethyl ketone (MEK), or any combination thereof.

22. The coating composition according to claim 14, wherein the coating composition is substantially free of formaldehyde, isocyanate, and styrene.

23. The coating composition according to claim 14, wherein the coating composition is cured at a temperature less than about 60° C. for less than about 10 minutes.

24. The coating composition according to claim 14, wherein the coating composition is cured at a temperature from about 20° C. to about 25° C. for less than about 12 hours.

25. A stain, a primer, a sealer, or a topcoat comprising the coating composition according to claim 14.

26. The coating composition according to claim 14, comprising the contact product of a first component and an optional second component, wherein:
a) the first component comprises:
(i) a highly-branched, allyl ether-functionalized, unsaturated polyester resin;
(ii) at least one(meth)acrylic-functionalized monomer or poly(meth)acrylate; and
(iii) at least one metal drier; and
(b) the optional second component comprises at least one peroxide compound.

27. The coating composition according to claim 14, wherein the highly-branched, allyl ether-functionalized, unsaturated polyester resin is prepared by the reaction of:
(a) a hydroxyl-functionalized, allyl ether-functionalized, optionally carboxyl-functionalized, unsaturated polyester; and
(b) a polyisocyanate, an isocyanate prepolymer, or a combination thereof.

28. A method comprising:
(a) providing a coating composition according to claim 14; and
(b) applying the coating composition to a substrate.

29. The method according to claim 28, wherein the substrate is wood, a fabricated wood product, metal, plastic, or any combination thereof.

30. The method according to claim 28, further comprising curing the coating composition to form a cured coating.

31. A method of preparing a coating composition, comprising contacting a first component and an optional second component, wherein:
(a) the first component comprises the contact product of:
(i) a highly-branched, allyl ether-functionalized, unsaturated polyester resin;
(ii) optionally, a polyacrylate, a polymethylacrylate, a polymethyl methacrylate, a polyethylene glycol acrylate, a polyethylene glycol methylacrylate, a polyethylene glycol methyl methacrylate, or any combination thereof; and
(iii) optionally, at least one thermoplastic resin modifier, at least one metal drier, at least one pigment, at least one filler, at least one wax, at least one colorant, at least one surface active additive, at least one rheology-controlling agent, at least one solvent, or any combination thereof; and
(b) the optional second component comprises at least one peroxide compound.

32. The method of preparing a coating composition according to claim 31, wherein the highly-branched, allyl ether-functionalized, unsaturated polyester resin comprises the contact product of:
(a) a hydroxyl-functionalized, allyl ether-functionalized, optionally carboxyl-functionalized, unsaturated polyester; and
(b) a polyisocyanate, an isocyanate prepolymer, or a combination thereof.
